(19) United States
(12) Patent Application Publication
(10) Pub. No.: US 2010/0208466 A1
(43) Pub. Date: Aug. 19, 2010

(54) LED LAMP

(75) Inventors: QIANG LUO, Shenzhen City (CN); GUANG YU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/465,649

(22) Filed: May 14, 2009

(30) Foreign Application Priority Data
Feb. 19, 2009 (CN) 200910300487.4

(51) Int. Cl. F21V 7/00; F21S 13/10

(52) U.S. Cl. 362/297; 362/310; 362/431

(57) ABSTRACT

An LED lamp includes a base, a reflector arranged on a top of the base, an LED module attached to the top of the base and surrounding the reflector, an envelope arranged on the top of the base and enclosing the LED module and the reflector, a shield secured on the envelope and covering the reflector and the LED module, and an inserting post fixed on a bottom of the base for facilitating inserting into a foundation to secure the LED lamp thereon. A bottom surface of the shield is coated with a reflecting coating for reflecting light emitted by the LED module.

### BACKGROUND

1. Technical Field

The present disclosure relates to LED (light emitting diode) lamps for lighting purpose and, more particularly, to an improved LED lamp having a novel structure for use in the outdoors.

2. Description of Related Art

An LED lamp is a type of solid-state lighting that utilizes LEDs as a source of illumination. The LED has an advantage that it is resistant to shock, and has an almost eternal lifetime under a specific condition; thus, the LED lamp is intended to be a cost-effective yet high quality replacement for incandescent and fluorescent lamps.

Known implementations of LED modules in an LED lamp make use of a plurality of individual LEDs to generate light that is sufficient. Since a lighting angle of the LEDs is generally restricted in a narrow range, light of the LED lamp is of unsatisfactory spatial distribution, whereby a more larger illumination area can not be provided.

What is needed, therefore, is an improved LED lamp which has a simple and novel structure, whereby the LED lamp is suitable to mass-manufacture and has a satisfactory illumination area.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric, assembled view of an LED lamp in accordance with an embodiment of the present disclosure.

FIG. 2 is an exploded view of the LED lamp in FIG. 1.

FIG. 3 is a view similar to FIG. 2, but shown from a different aspect.

FIG. 4 is a cross-sectional view of the LED lamp in FIG. 1, taken along line IV-IV thereof.

### DETAILED DESCRIPTION

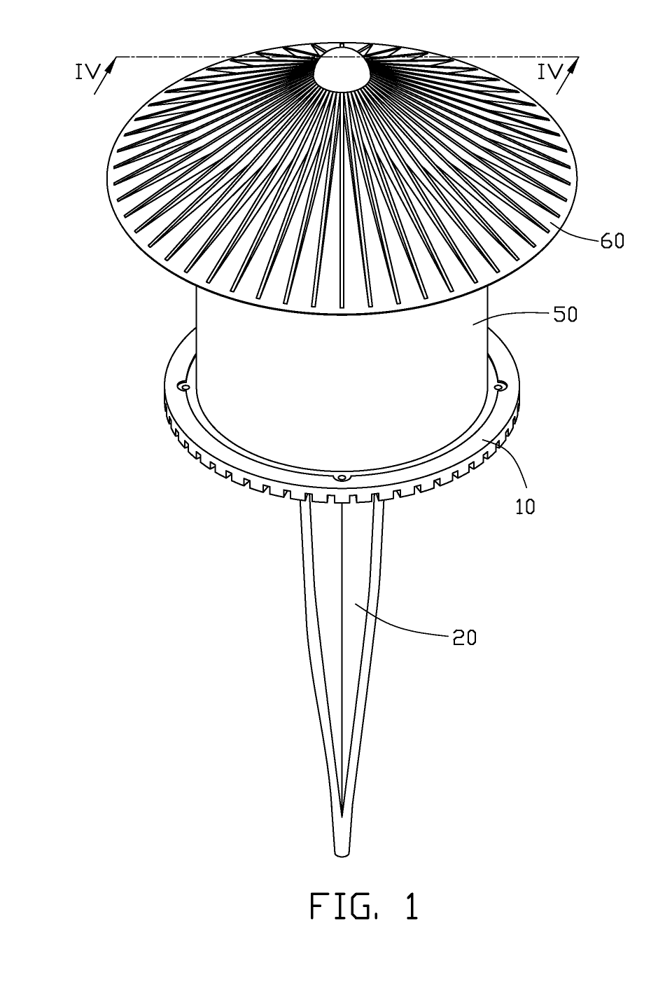

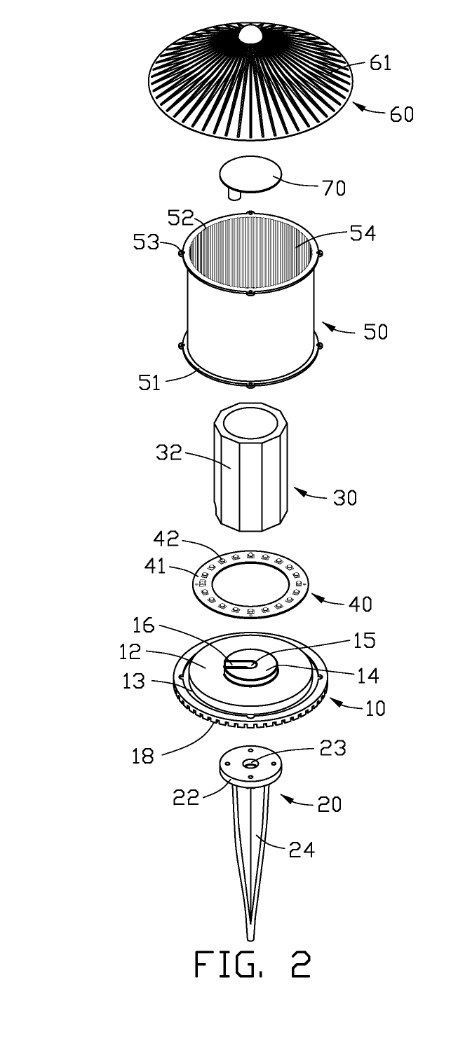

Referring to FIGS. 1-2, an LED lamp in accordance with an embodiment comprises a base 10, an inserting post 20 connecting the base 10, a reflector 30 mounted on the base 10, an LED module 40 attached to the base 10 and surrounding the reflector 30, an envelope 50 mounted on the base 10 and enclosing the LED module 40 and the reflector 30 therein, and a shield 60 secured on the envelope 50 and covering the reflector 30 and the envelope 50. A rectifier 70 is located below the shield 60 and engages with the shield 60 for electronically connecting the LED module 40.

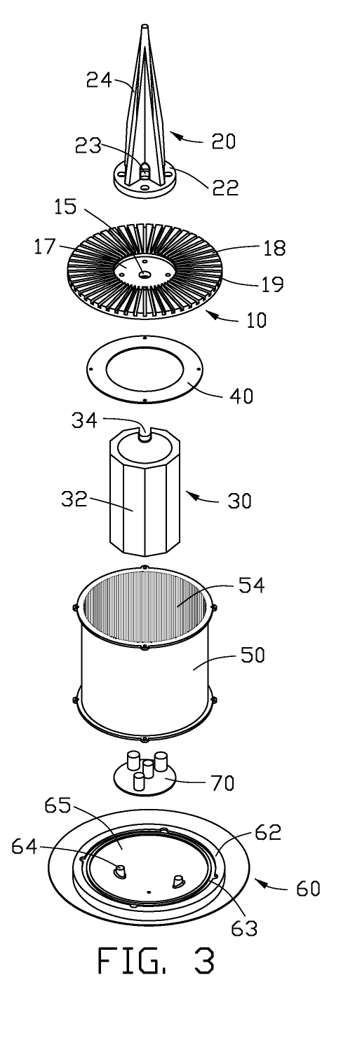

Referring to FIGS. 2-3, the base 10 is made of heat conductive material such as aluminum or the like and is substantially a round plate. A first round platform 12 protrudes from a top surface of the base 10. A groove 13 surrounds the first platform 12 for receiving a bottom end of the envelope 50 therein. A second round platform 14 protrudes upwardly from the first platform 12. The first and second platforms 12, 14 and the base 10 are homocentric with each other. A hole 15 is defined in a centre of the base 10. A slot 16 is radially defined in the second platform 14 and communicated with the hole 15. A round recess 17 is defined in a centre of a bottom surface of the base 10 for receiving a top end of the inserting post 20 therein. A plurality of grooves 19 are radially defined in the bottom surface of the base 10 to surround the recess 17 to thereby form a plurality of bulges 18 between the grooves 19. The bulges 18 are configured to increase a heat dissipating surface area of the base 10, whereby heat generated by the LED module 40 can be rapidly dissipated.

The inserting post 20 is fixed to the bottom surface of the base 10 and used for inserting into a foundation such as the ground to secure the LED lamp at a desired position. The inserting post 20 comprises a round head portion 22 engaged with the base 10 and an inserting portion 24 extending downwardly from the head portion 22. The head portion 22 is received in the recess 17 of the base 10 and engaged with the base 10 by screws (not show) extending therethrough. An opening 23 is defined in the head portion 22 for lead wires (not shown) extending through the head portion 22 and the hole 15 of the base 10 to electrically connect with the LED module 40 and the rectifier 70. The inserting portion 24 is cross-shaped and gradually decreases in diameter thereof to form a pointed bottom end, to thereby facilitate insertion of the inserting post 20 into the ground.

The reflector 30 is tube-shaped and has a plurality of rectangular and identical outer sidewalls 32 and a cylindrical inner wall (not labeled). Each sidewall 32 has a flat face. The sidewalls 32 reflect light emitted from the LED module 40 out of the envelope 50. A notch 34 is defined at a bottom end of the reflector 30 corresponding to the slot 16 of the base 10 for extension of the lead wires therethrough to connect with the LED module 40. An inner diameter of the reflector 30 is slightly smaller than a diameter of the second platform 14 of the base 10, whereby the reflector 30 can interferentially and fixedly engage with a periphery of the second platform 14.

The LED module 40 comprises an annular mounting board 41 and a plurality of LEDs 42 mounted on the board 41. The LED module 40 is mounted on the first platform 12 and encloses the reflector 30.

The envelope 50 is substantially tube-shaped and forms a bottom flange 51 at a bottom end, and a top flange 52 at a top end thereof. The bottom flange 51 is received in the groove 13 of the base 10. Each of the bottom and top flanges 51, 52 forms four ears 53 thereon. A screw hole (not labeled) is defined in each of the ears 53 for screws extending therein to engage with the base 10 and the shield 60, respectively. A plurality of wave-liked ridges 54 are formed in an inner surface of the envelope 50 and extend along an axis of the envelope 50. The ridges 54 serve to make the light irradiating therethrough more soft and uniform.

The shield 60 is tapered and has a shape of a cap. A plurality of ribs 61 are formed at a top surface of the shield 60 and extend radially from a top end of the shield 60. A rim 62 extends downwardly from a bottom surface of the shield 60. An annular groove 63 is defined in the rim 62 for receiving the top flange 52 of the envelope 50. Two tabs 64 extend downwardly from the bottom surface of the shield 60 and are positioned in an inner side of the rim 62. A reflecting coating 65 is coated on the bottom surface of the shield 60 for reflecting the light generated from the LED module 40. It is to be understood that, the reflecting coating 65 can be coated on the whole of the bottom surface of the shield 60, or on a part of the bottom surface of the shield 60 which is located in the inner side of the rim 62. The rectifier 70 is engaged between the tabs 64 and locked by the tabs 64. The shield 60 serves as a protective component for preventing rainwater, dust, etc. from entering into the LED lamp. Understandably, the shield 60, which is made of heat conductive material, can also serve as a heat dissipating component dissipating heat of the rectifier 70 and heat cumulated in the LED lamp.

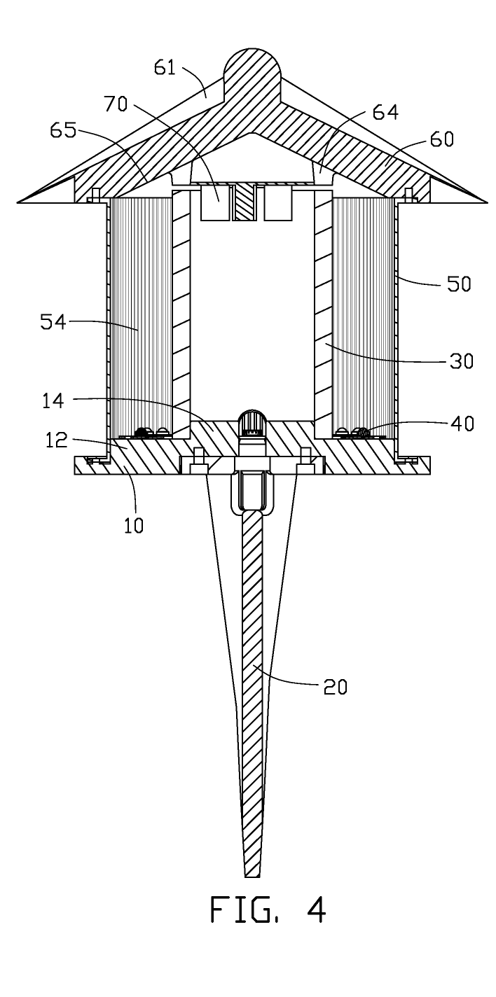

Please also referring to FIG. 4, in assembly, the LED module 40 is mounted on the first platform 12 of the base 10. The reflector 30 is arranged on the first platform 12 and engaged with the second platform 14 of the base 10. The bottom flange 51 of the envelope 50 is received in the groove 13 of the base 10. The rectifier 70 is electronically connected with the LED module 40, located below the shield 60 and locked by the tabs 64 of the shield 60. The shield 60 is located on the envelope 50 and covers the reflector 30 and the LED module 40. The top flange 52 of the envelope 50 is received in the groove 63 of the shield 60. The bottom and top flanges 51, 52 are respectively secured to the base 10 and the shield 60 by screws. The inserting post 20 is fixed to the base 10. Due to the tube shape of the reflector 30, the reflector 30 can provide a receiving space for accommodating the rectifier 70 therein.

In operation, the heat generated by the LED module 40 can be absorbed by the base 10 and dissipated therefrom. The light emitted from the LED module 40 can be reflected by the outer sidewalls 32 of the reflector 30 and the reflecting coating 65 at the bottom surface of the shield 60. Therefore, the light emitted from the planar LED module 40 can be reflected in a multidirectional manner, which increases the illumination area of the LED lamp.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An LED (light emitting diode) lamp, comprising:
a base;
a reflector arranged on a top of the base;
an LED module attached to the top of the base and surrounding the reflector;
an envelope arranged on the top of the base and enclosing the LED module and the reflector therein;
a shield secured on the envelope and covering the reflector and the LED module; and
an inserting post fixed on a bottom of the base for inserting into an object to secure the LED lamp thereon.

2. The LED lamp as claimed in claim 1, wherein the base defines a plurality of grooves in the bottom thereof to thereby form a plurality of bulges between the grooves.

3. The LED lamp as claimed in claim 1, wherein a top of the base protrudes upwardly to form a first round platform, the envelope surrounds the first platform, and the LED module is attached on the first platform.

4. The LED lamp as claimed in claim 3, wherein a second round platform protrudes upwardly from a center of the first platform, and a bottom end of the reflector is engaged with a periphery of the second platform.

5. The LED lamp as claimed in claim 4, wherein the second platform defines a hole penetrating through the base to communicate with the inserting post, and defines a groove communicating the hole, and the bottom end of the reflector defines a notch communicating with the hole and the groove of the second platform for lead wires extending therethrough to electronically connect the LED module.

6. The LED lamp as claimed in claim 4, wherein the reflector is tube-shaped and an inner diameter of the reflector is slightly smaller than a diameter of the second platform for the reflector interferentially engaging with the periphery of the second platform.

7. The LED lamp as claimed in claim 6, wherein the reflector forms a plurality of elongated reflecting sidewalls at an outer surface thereof.

8. The LED lamp as claimed in claim 3, wherein the top of the base defines a groove around the first platform, a bottom of the envelope being received in the groove in the top of the base.

9. The LED lamp as claimed in claim 1, wherein the envelope forms a plurality of wave-like ridges at an inner surface thereof.

10. The LED lamp as claimed in claim 1, wherein a reflecting coating is applied to a downside surface of the shield to reflect light emitted from the LED module.

11. The LED lamp as claimed in claim 1, wherein the shield is tapered and has a shape of a cap with a plurality of ribs formed on a top surface thereof.

12. The LED lamp as claimed in claim 1, further comprising a rectifier electrically connecting the LED module, the rectifier being located below the shield and attached to a downside surface of the shield.

13. An LED lamp, comprising:
a base with a plurality of heat dissipating bulges formed at a bottom surface thereof, a first platform formed on a top surface thereof, and a second platform formed on the first platform;
a reflector mounted on the base and engaging with the second platform, a plurality of flat reflecting sidewalls being formed on an outer surface of the reflector;
an envelope arranged on the base and surrounding the first platform;
an LED module attached to the first platform of the base and positioned between the reflector and the envelope;
a shield engaging with a top of the envelope and covering the LED module and the reflector, a bottom surface of the shield coated with a reflecting coating for reflecting light emitted by the LED module; and
a rectifier located attached to the bottom surface of the shield.

14. The LED lamp as claimed in claim 13, further comprising an inserting post fixed on the bottom surface of the base, the inserting post has a pointed bottom end for facilitating inserting into a foundation to fix the LED lamp thereon.

15. The LED lamp as claimed in claim 14, wherein the base define a hole therein, the reflector defines a notch at a bottom thereof, and the inserting post defines an opening therein, the hole, the notch and the opening are communicated with each other for extension of lead wires therethrough to electronically connect the LED module and the rectifier.

16. The LED lamp as claimed in claim 13, wherein the envelope forms a plurality of ridges at an inner surface thereof.

17. The LED lamp as claimed in claim 13, wherein the shield is tapered and has a shape of a cap and forms a plurality of radial ribs at a top surface thereof and a rim for engaging with the top of the envelope.
